(19) United States
(12) Patent Application Publication
(10) Pub. No.: US 2007/0143938 A1
(43) Pub. Date: Jun. 28, 2007

(54) Electric toothbrush

(76) Inventor: Gregory John McDougall, Guadelupe (PH)

Correspondence Address: LEYDIG VOIT & MAYER, LTD, 700 THIRTEENTH ST. NW, SUITE 300, WASHINGTON, DC, 20005-3960, US

(21) Appl. No.: 11/314,084

(22) Filed: Dec. 22, 2005

(51) Int. Cl. A61C 17/22

(52) U.S. Cl. 15/22.1

(57) ABSTRACT

An electric toothbrush has a casing with a handle and a neck extending from the handle. A rotary drive shaft extends within the casing and comprises two radially opposed offset crank portions at a distal end of the neck. A tuft block is located at the distal end of the neck and is coupled with the two offset crank portions to cause a wobbling motion in the tuft block upon rotation of the shaft. An LED light source in the visible region of blue or red light is provided between rows of bristles for fighting bacteria and other oral conditions.

### BACKGROUND TO THE INVENTION

1. Field of the Invention

The present invention relates to electric toothbrushes. More particularly, although not exclusively, the invention relates to an electric toothbrush, having a tuft block that is moved by a rotating crankshaft.

2. Background Information

There are many known electric toothbrush mechanisms having pivotally oscillating tuft blocks. Some such mechanisms are known to include a pivotally oscillating circular tuft block that oscillates back and forth about an axis that extends parallel to the bristles. The centre-most bristles of such tuft blocks provide little, if any cleaning action.

Other electric toothbrushes are known, which comprise a bristle head that moves reciprocally back and forth in a direction parallel to the longitudinal axis of the toothbrush. Such a toothbrush is disclosed in U.S. Pat. No. 4,995,131. This type of bristle movement has been criticised as being inefficient, as the bristle tips move along the gum line, instead of across the gum line.

The brushing action of known toothbrushes is also only effective at removing bacteria from the teeth and gums. It does not kill or inactivate the bacteria. Any bacteria not removed will continue to multiply quickly in the warm moist environment of the mouth. The brush head also becomes a braiding ground for bacteria which can be transferred to the mouth during subsequent brushing operations.

### SUMMARY OF THE INVENTION

It is an object of the present invention to overcome or substantially ameliorate at least one of the above disadvantages and/or more generally to provide an electric toothbrush with improved brushing action.

It is a further object of the present invention to provide an electric toothbrush which is more effective in removing bacteria from the teeth and gums, or which is more inclined to prevent growth of bacteria.

There is-disclosed herein an electric toothbrush comprising a casing having a handle and a neck extending from the handle, a rotary drive shaft extending within the casing and comprising two radially opposed offset crank portions at a distal end of the neck, a tuft block at the distal end of the neck and coupled with the two offset crank portions to cause a wobbling motion in the tuft block upon rotation of the shaft.

Preferably, the tuft block has flanges at its ends for coupling to the two offset crank portions so that the ends of the tuft block move in eccentric circles upon rotation of the shaft.

Preferably, the tuft block includes two parallel rows of bristles.

Preferably, the tuft block includes a light source located between the rows of bristles.

Preferably, the light source emits light in the blue region of the visible spectrum.

Preferably, the bristles have an average diameter of 0.01 millimeters.

Preferably, there is located in the housing a battery and a motor coupled to the drive shaft for rotating the shaft at between 8,000 and 10,000 revolutions per minute.

Preferably, the casing is formed integrally with the handle and within which there is located a battery and a motor coupled to the drive shaft.

Further aspects of the invention will become apparent from the following description.

### BRIEF DESCRIPTION OF THE DRAWINGS

A preferred form of the present invention will now be described-by way of example with reference to the accompanying drawings, wherein:

FIGS. 1 and 2 are schematic views of a toothbrush according to the invention, and

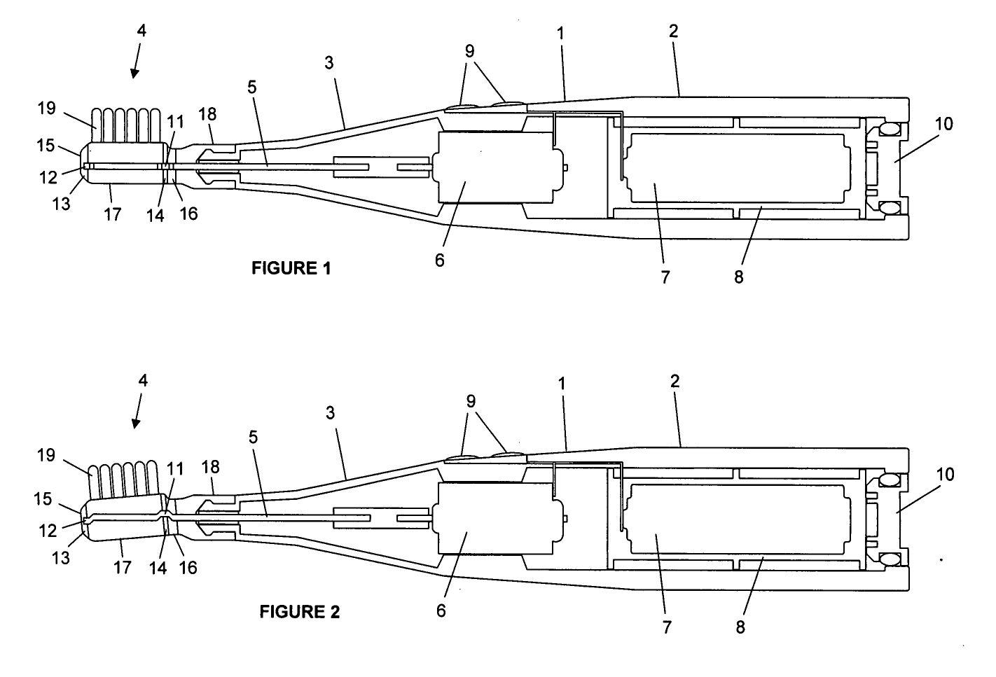

FIGS. 3 and 4 are views of the tuft block of the toothbrush.

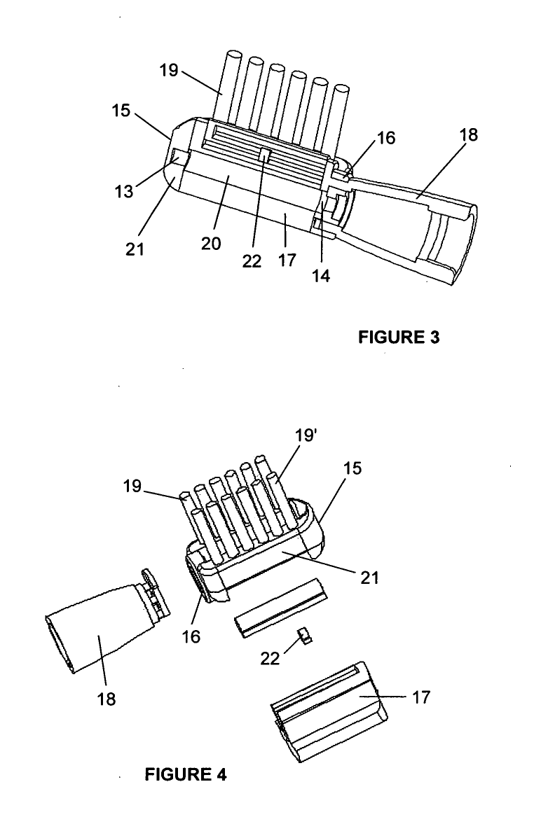

### DETAILED DESCRIPTION OF THE DRAWINGS

In the accompanying drawings there is depicted an electric toothbrush comprising a casing 1 formed integrally with a handle 2 and a neck 3 extending from the handle 2 to a tuft block 4. A rotary drive shaft 5 extends within the casing 1 thought the neck 3 to the tuft block 4. Within the handle 2 is located a motor 6 coupled to the drive shaft 5 for rotating the shaft 5. A battery 7 in a battery holder 8 supplies power for the motor 6. The battery 7 is changeable through screw in base 10. Buttons .9 on the casing 1 are used to start and stop the toothbrush. The above arrangement is well known in the art.

The distal end of the shaft 5 at which the tuft block 4 is located has two radially opposed offset crank portions 11, 12. The shaft 5 passes thought a channel 20 in the tuft block 4 which has two flanges 13, 14, one at each of its ends, that couple with the two offset crank portions 11, 12 respectively. By this arrangement, when the shaft 5 is rotated the ends 15, 16 of the tuft block 4 move in eccentric circles to cause a wobbling motion of the tuft block 4. A flexible boot 18 is provided at the coupling between the neck 3 and tuft block 4 allow the tuft block 4 movement.

For optimum clearing of teeth and gums by the wobbling motion the shaft 5 is rotated at between eight thousand (8,000) and ten thousand (10,000) revolutions per minute.

The tuft block 4 comprises an outer shell 21 having two parallel rows of bristles 19. The bristles 19 have an average diameter of 0.01 millimeters. Within the outer shell 21 is an inset portion 17. The inset portion 17 includes a light emitting diode (LED) light source 22 that emits light in the blue region of the visible spectrum from between the two rows of bristles 19. The light source 22 is powered from the battery 7 by thin flexible wires that pass parallel with the shaft 5. Recent research in the USA has found that blue and some green light, particularly in the wavelengths ranged from 380 to 520 nanometers, can kill or inactivate certain oral pathogens.

In an alternative embodiment the light source 22 may emit light in the red visible spectrum, particularly in the wavelengths ranged from 535 to 785 nanometers, which has,been found to have some beneficial affect of cancerous cells and so may well help fight gum and oral cancer.

Thus, by the arrangement of two offset crank portions 11, 12 to cause a high-speed wobbling motion of the brush head 4, and a light source 22 in the bead to help kill or inactive oral pathogens, the current invention provide a superior teeth cleaning experience.

It should be appreciated that modifications and/or alternations obvious to those skilled in the art are not to be considered as beyond the scope of the present invention.

1. An electric toothbrush comprising:
a casing having a handle and a neck extending from the handle,
a rotary drive shaft extending within the casing and comprising two radially opposed offset crank portions at a distal end of the neck, and
a tuft block at the distal end of the neck and coupled with the two offset crank portions to cause a wobbling motion in the tuft block upon rotation of the shaft.

2. The electric toothbrush of claim 1 wherein the tuft block has flanges at ends of the tuft block for coupling to the two offset crank portions so that the ends of the tuft block move in eccentric circles upon rotation of the shaft.

3. The electric toothbrush of claim 1 wherein the tuft block includes two parallel rows of bristles.

4. The electric toothbrush of claim 3 wherein the tuft block includes a light source located between the rows of bristles.

5. The electric toothbrush of claim 4 wherein the light source emits light in the blue region of the visible spectrum.

6. The toothbrush of claim 3 wherein the bristles have an average diameter of 0.01 millimeters.

7. The electric toothbrush of claim 1 including, located in the housing, a battery and a motor coupled to the drive shaft for rotating the shaft at between 8,000 and 10,000 revolutions per minute.

8. The electric toothbrush of claim 1 wherein the casing is integral with the handle and including, within the casing, a battery and a motor coupled to the drive shaft.
